(19) United States
(12) Patent Application Publication
(10) Pub. No.: US 2009/0185628 A1
(43) Pub. Date: Jul. 23, 2009

(54) Receiving circuit

(75) Inventor: Hiroshi Inose, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/289,259

(22) Filed: Oct. 23, 2008

(30) Foreign Application Priority Data
Jan. 21, 2008 (JP) 10512/2008

(51) Int. Cl. H04N 7/52

(52) U.S. Cl. 375/240.28; 375/E07.267

(57) ABSTRACT

Disclosed herewith is a receiving circuit that receives data including video data that are digital signals. Each of conventional receiving circuits has been required to use high withstand voltage elements in its connection detection circuit higher than those of other circuits. Thus those conventional receiving circuits have been confronted with a problem that increases the circuitry scale. On the other hand, in order to solve the above conventional problem, the receiving circuit of the present invention includes a first clock detection circuit that detects presence of a read clock used to read the unique ID of each receiving side device; a second clock detection circuit that detects presence of a clock of send data; and a link state detection circuit that inputs a detection result of each of the first and second clock detection circuits and detects a state of linking with an object sending side device according to at least one of a read clock and a send clock.

### FIELD OF THE INVENTION

The present invention relates to a receiving circuit and more particularly to a receiving circuit that detects a link state according to a signal output from a sending side device.

### BACKGROUND OF THE INVENTION

In recent years, there have often been carried out various kinds of controlling according to a decision of whether or not a third party of communication is connected in each of the subject sending and receiving side devices. The DVI (Digital Visual Interface) standard is one of the standards that include such a connection check in control operations. The HDMI (High-Definition Multimedia Interface) standard is another, which includes the contents of the DVI standard as video data transfer related functions.

Hereunder, there will be described how to detect a connection in case of those DVI and HDMI standards. FIG. 4 shows a block diagram of a receiving circuit 100 that receives signals conforming to the DVI standard in a conventional example. As shown in FIG. 4, the receiving circuit 100 is connected to its object sending side device through a connector. The receiving circuit 100 includes a +5V detection circuit 101, a TMDS clock receiving circuit 102, a DDC receiving circuit 103, and a display device control circuit 104. The +5V receiving circuit receives a +5V signal output from a sending side device through a +5V terminal of the connector and through another terminal P101. The +5V detection circuit 101, upon detecting the +5V signal, outputs a +5V detection signal to the display device control circuit 104. The display device 104 is then activated by the +5V detection signal. The +5V terminal and the HPD terminal are connected to each other through a resistor R. Thus the 5V signal is output as an HPD (Hot Plug Detect) signal to the sending side device through the HPD terminal. The sending side device then recognizes the state of connection to the object receiving side device according to the HPD signal.

The TMDS clock receiving circuit receives the TMDS (Transition Minimized Differential Signaling) clock, which is a send clock of send data and outputs the TMDS signal to the display device control circuit 104. This TMDS clock is a differential signal; its positive phase side clock is supplied to the object through the TMDS+ terminal and another terminal P102 and its opposite phase side clock is supplied to the object through the TMDS− terminal and another terminal P103. The DDC receiving circuit 103 receives the DDC (Display Data Channel) clock used to read information from an EDID (Extended Display Identification Data) ROM 110 and outputs the DDC signal to the display device control circuit 104. The EDID ROM 110 stores information related to the receiving side device (e.g. a display device). The sending side device decides the format of data to be sent to the sending side device according to the information read from the EDID ROM 110. The DDC clock is output to the DDC receiving circuit 103 through the DDC clock terminal and through the terminal P104 respectively and the information read from the EDID ROM 110 is output to the sending side device through the DDC data terminal, then output to the DDC receiving circuit 103 through the terminal P105.

FIG. 5 shows sequences for showing how a control state changes in this receiving circuit. As shown in FIG. 5, the receiving circuit 100 decides a link OFF state with respect to the object sending side device if there is no +5V signal input detected, then stops the operation of, for example, the display device control circuit 104. Upon detection of a +5V signal input, the receiving circuit 100 recognizes the establishment (ON) of a link with the object sending side device, then notifies the link active state to the display device control circuit 104 and turns on the display device. Furthermore, the receiving circuit 100, when instructed to go into the link inactive state from the sending side device, goes into a power save mode to reduce the power consumption in operation. If not instructed to go into the link active state from the sending side device for a predetermined time, the receiving circuit 100 goes into an operation mode in which the power consumption is further reduced. On the other hand, if instructed to go into the link active state from the sending side device in the power save mode, the receiving circuit 100 turns on the display device again.

The conventional receiving circuit recognizes the state of connection to the subject sending side device in such a way according to the +5V signal. The non-patent document 1 (Digital Visual Interface Specification Revision 1.0 Appendix C. Digital Monitor Power State) discloses this connection state checking method according to the DVI standard in detail. The patent document 1 (JP-A-2007-225980) also discloses another example of how to recognize the connection state in a sending side device. Concretely, the patent document 1 discloses how a sending side device recognizes the connection state when a receiving side device receives video signals that are analog signals. A route for sending the DDC clock and DDC data generally employs a pull-up configuration in the receiving side device. In such a sending route of a pull-up configuration, the potential of the sending route changes in accordance with the connection state of the sending side device. Consequently, in the patent document 1, the connection state is recognized according to the potential of this sending route. In the receiving side device, however, the sending route is usually kept pulled up, so the receiving side device cannot recognize this potential change. Thus the receiving side device cannot use the method disclosed in the patent document 1.

### SUMMARY

As described above, the DVI and HDMI standards enable the state of connection between a receiving circuit and a sending side circuit to be recognized with use of a +5V signal. In recent years, however, the manufacturing processes of semiconductor devices have been micronized more and more and when forming a high withstand voltage element that can withstand a 5V voltage, the size of the element comes to be much larger than other low withstand voltage circuits. In the above receiving circuit 100, therefore, the +5V detection circuit becomes much larger in circuit scale than other circuits, so the semiconductor device chip size of the receiving circuit 100 has not been reduced. This has been a problem.

Under such circumstances, it is an object of the present invention to provide a receiving circuit capable of receiving send data including video data that are digital signals. The receiving circuit includes a first clock detection circuit that detects presence of a read clock used to read a unique ID of each receiving side device; a second clock detection circuit that detects presence of a send clock of the send data; and a link state detection circuit that inputs a detection result of each of the first and second clock detection circuits and detects a link state with respect to a sending side device according to at least one of the read clock and the send clock.

The receiving circuit can recognize the state of the link with an object sending side device according to at least one of the first and second clocks. In other words, the receiving circuit of the present invention can recognize the state of linking without using the 5V voltage, so the receiving circuit can be configured without using any 5V withstand voltage elements.

The present invention can realize a compact receiving circuit that can recognize the state of linking with each sending side device.

### BRIEF DESCRIPTION OF THE DRAWINGS

FIG. 1 is a block diagram of a receiving circuit in a first embodiment of the present invention;

FIG. 2 is a sequence chart for showing how the operation state of the receiving circuit changes in the receiving circuit in the first embodiment of the present invention;

FIG. 3 is a block diagram of a receiving circuit in a second embodiment of the present invention;

FIG. 4 is a block diagram of a conventional receiving circuit; and

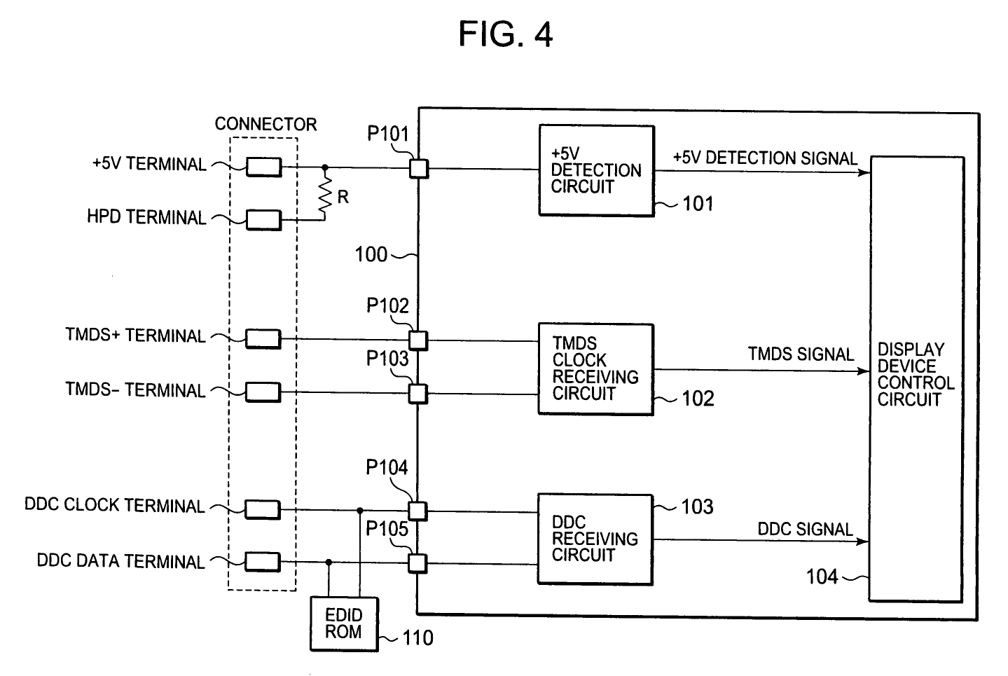

FIG. 5 is a sequence chart for showing how the operation state of the receiving circuit changes in the conventional receiving circuit.

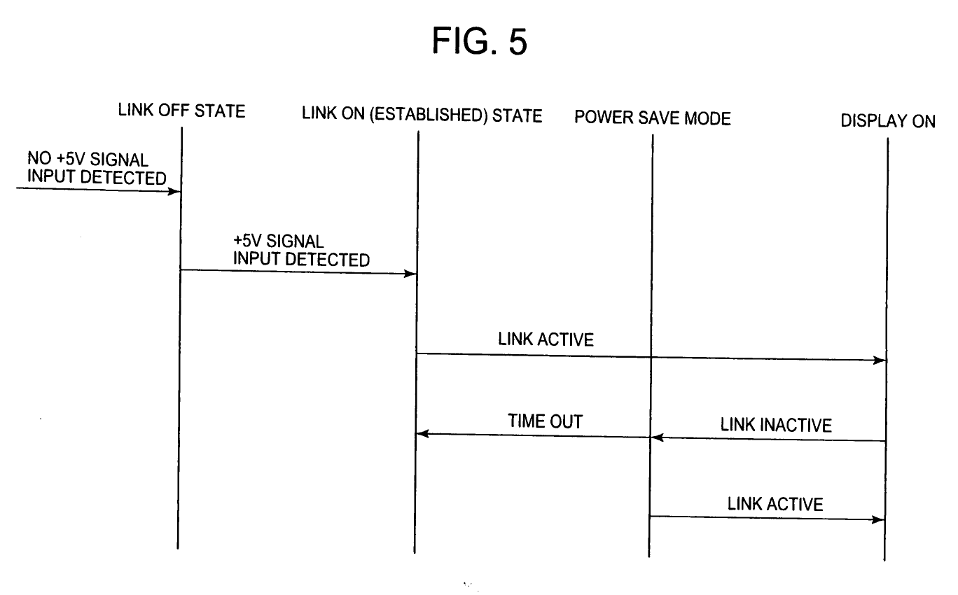

### DETAILED DESCRIPTION OF THE PREFERRED EMBODIMENTS

### First Embodiment

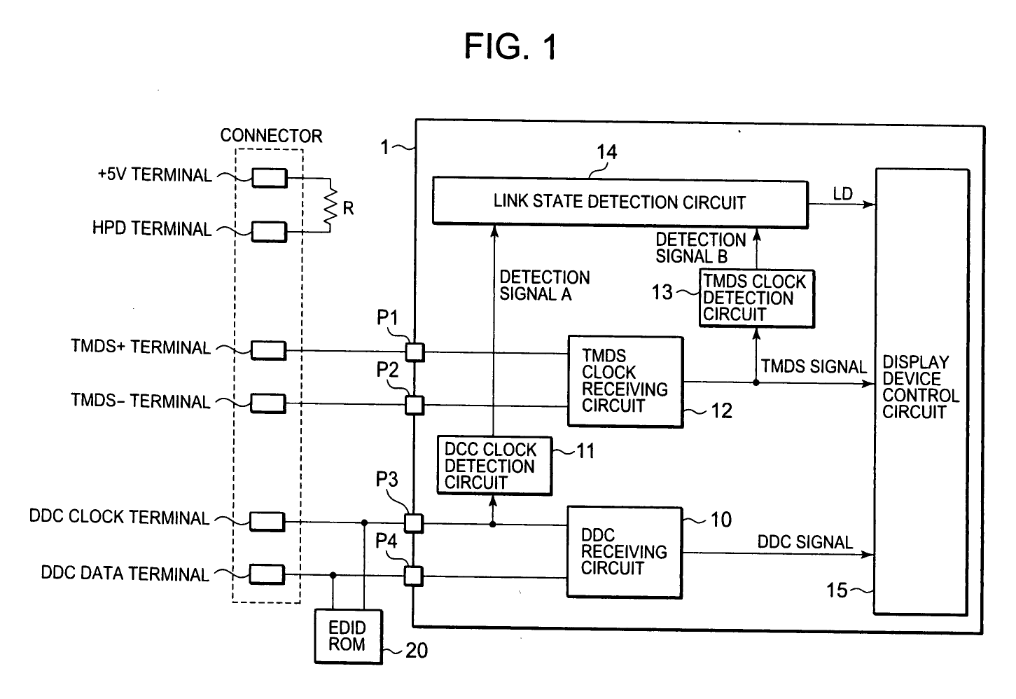

Hereunder, there will be described the first embodiment of the present invention with reference to the accompanying drawings. FIG. 1 is a block diagram of a receiving circuit 1 in this first embodiment. In the following description, it is premised that data is sent/received according to a method conforming to the DVI or HDMI standard. As shown in FIG. 1, the receiving circuit 1 includes a first clock receiving circuit (e.g., DDC receiving circuit) 10; a first clock detection circuit (e.g., DDC clock detection circuit) 11; a second clock receiving circuit (e.g., TMDS clock receiving circuit) 12; a second clock detection circuit (e.g., TMDS clock detection circuit) 13; a link state detection circuit 14; a control circuit (e.g., display device control circuit) 15; and terminals P1 to P4.

A receiving side device having the receiving circuit 1 includes a connector and an EDID ROM 20. The connector has a +5V terminal, an HPD terminal, a TMDS+ terminal, a TMDS− terminal, a DDC clock terminal, and a DDC data terminal. The receiving circuit 1 is connected to a sending side device through the connector. Among the terminals of the connector, the +5V and HPD terminals are not connected to the receiving circuit 1. The +5V and HPD terminals are connected to each other through a resistor R.

The DDC receiving circuit 10 receives a read clock (e.g., DDC (Display Data Channel) clock) inputted through the DDC clock terminal and the terminal P3 and outputs a DDC signal to the display device control circuit 15. The DDC receiving circuit 10 receives information through the terminal P4. The information is read from the EDID (Extended Display Identification Data) ROM 20 through the DDC data terminal. The data stored in the EDID ROM 20 is, for example, information related to such receiving side devices as their unique IDs. The EDID ROM 20 receives the DDC clock through a line connected between the DDC clock terminal and the terminal P3 and outputs the information through the line connected between the DDC data terminal and the terminal P4.

The DDC clock detection circuit 11 receives the DDC clock through a line connected between the terminal P3 and the DDC receiving circuit 10 and detects the DDC clock, then outputs a detection signal A. The DDC clock detection circuit 11 detects the DDC clock through such a circuit as a clock counter and a frequency detection circuit. The DDC clock detection circuit 12 outputs a detection signal A only when detecting the DDC clock.

The TMDS clock receiving circuit 12 receives a send clock of send data (e.g., TMDS (Transition Minimized Differential Signaling) clock) and outputs a TMDS signal to the display device control circuit 15. The TMDS clock is a send clock of send data to be sent from a sending side device to the receiving circuit 1 through another route (not shown). The TMDS clock is a differential signal; its positive phase side clock is inputted through the TMDS+ terminal and through the terminal P1 while its opposite phase side clock is inputted through the TMDS− terminal and through the terminal P2 respectively.

The TMDS clock detection circuit 13 receives the TMDS signal and detects the TMDS clock, then outputs a detection signal B. The TMDS clock detection circuit 13 checks the presence of the TMDS clock through such a circuit as the clock counter, the frequency detection circuit, etc. and outputs a detection signal B when detecting the TMDS clock.

The link state detection circuit 14 detects the state of linking with the receiving circuit 1 and the object sending side device according to at least one of the detection signals A and B, then outputs a link detection signal LD to the display device control circuit 15. More concretely, the link state detection circuit 14 outputs the link detection signal LD if at least one of the detection signals A and B denotes clock sending.

The display device control unit 15 controls a device (e.g., a display device) connected in a succeeding step according to the TMDS signal, the DDC signal, and send data (not shown). The display device control unit 15 controls its own power state and the power state of the device in its succeeding step.

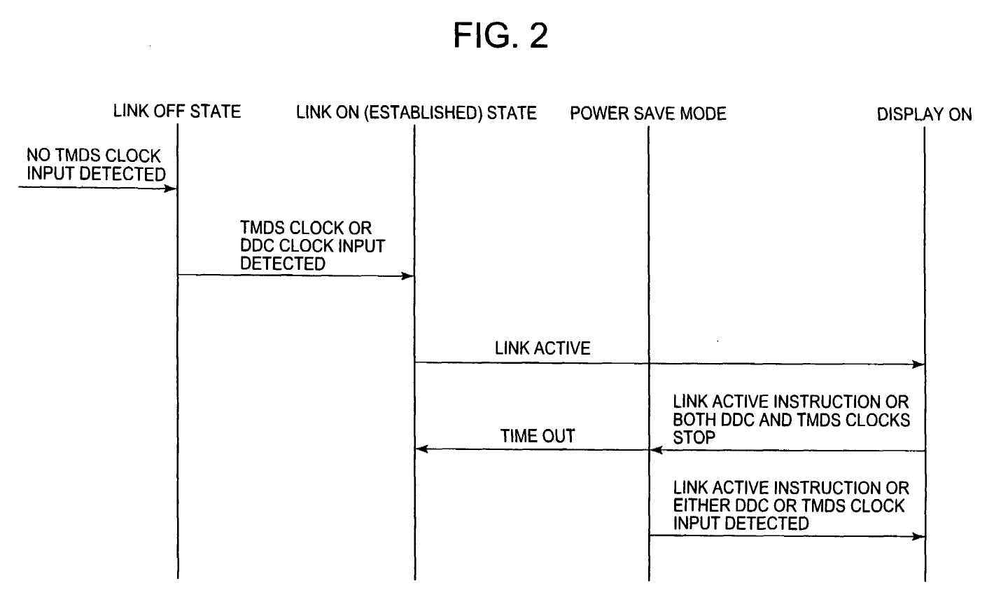

Next, there will be described the operation of the receiving circuit 1 in this first embodiment. FIG. 2 shows sequences of how the control state changes in the receiving circuit 1. As shown in the figure, the receiving circuit 1 decides the link OFF state with respect to the object sending side device if it receives none of the DDC clock and the TMDS clock. Then, for example, the receiving circuit 1 shifts the display device control circuit 15 to such a low power consumption mode as the standby or the like. After that, upon detecting an input of the DDC clock or the TMDS clock, the detection signal A or B denotes detection of the clock input. Consequently, the link state detection circuit 14 recognizes establishment of the link with the sending side device and outputs the link detection signal LD to the display device control circuit 15. Then, the display device control circuit 15 recognizes the instructed link active state and turns on the display device. On the other hand, when instructed to go into the link active state from the sending side device or when both of the DDC clock and the TMDS clock stop, the receiving circuit 1 shifts the display device control circuit 15 and the display device to a power save mode to reduce the power consumption. Then, if not receiving an instruction of going into the link active state from the sending side device for a predetermined time, the receiving circuit 1 drives display device control circuit 15 and the display device into an operation mode in which the power consumption is further reduced. On the other hand, if instructed moving into the link active state from the sending side device in the power save mode or when inputting any of the DDC clock and the TMDS clock, the receiving circuit 1 turns on the display device again.

As described above, the receiving circuit 1 in this embodiment can recognize the state of linking with an object sending side device by detecting an input of at least one of the DDC clock and TMDS clock. Consequently, the present invention makes it possible to configure the receiving circuit 1 without using any 5V withstand voltage elements that have been included in conventional receiving circuits. In other words, the present invention can configure the receiving circuit 1 with use of only low withstand voltage elements that are small in size. This is why the receiving circuit 1 can be reduced much in size.

The receiving circuit 1 in this embodiment can recognize the link-OFF state, which denotes that none of the DDC clock and the TMDS clock are inputted thereto. In such a link-OFF state, basically the receiving circuit 1 receives no data from any sending side devices. Consequently, upon detecting such a state, the receiving circuit 1 in this embodiment can shift circuits such as the display device control circuit 15 to a low power consumption mode according to the data sending state. The receiving circuit 1 in this embodiment can thus control the power supply of each receiving side device precisely, thereby reducing the power consumption of the receiving side device. On the other hand, conventional receiving circuits come to recognize a link-ON (established) state when receiving a +5V signal regardless of detection of the DDC clock or the TMDS clock. Consequently, those conventional receiving circuits cannot control the power supply of any devices according to whether or not there is detected any of the DDC clock and the TMDS clock.

### Second Embodiment

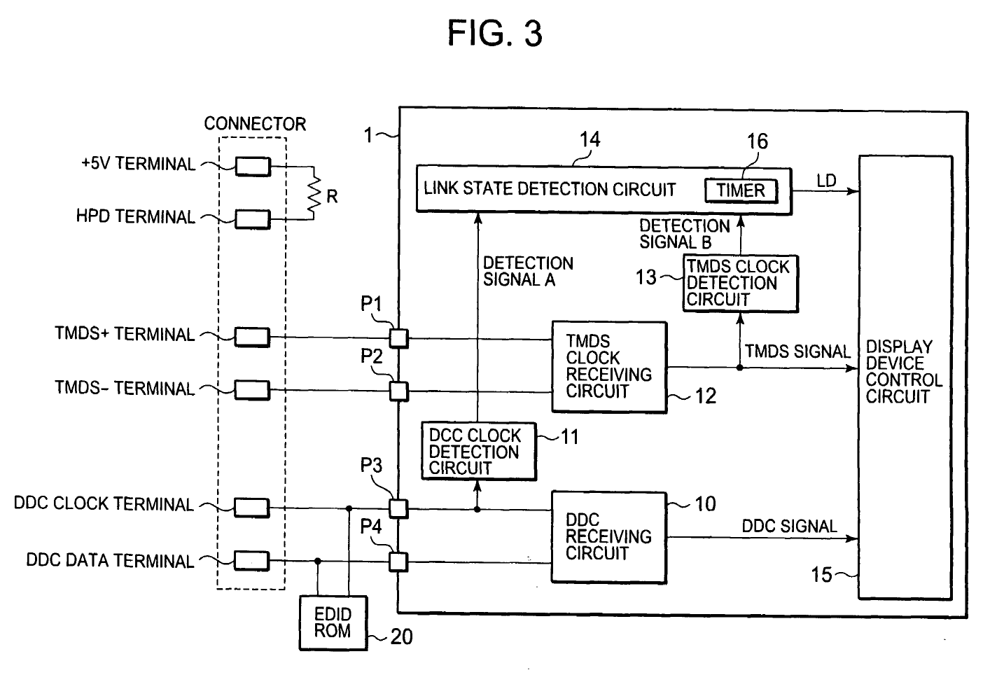

FIG. 3 shows a block diagram of a receiving circuit 1 in this second embodiment. As shown in the figure, a link state detection circuit 14 in this second embodiment includes a timer 16. In case of the DVI and HDMI standards, there is a slight difference in time between DDC clock sending stop and TMDS signal sending start at the starting time of the subject sending side device operation. Consequently, the receiving circuit 1 in the first embodiment comes to recognize such a time lag as a link-OFF state.

This is why the timer 16 is provided in the link state detection circuit 14 in this second embodiment, thereby counting the predetermined period, which starts at the notification of the DDC clock sending stop by the detection signal A. And the receiving circuit 1 is prevented from deciding such a link-OFF state until the count value reaches the predetermined value even when detection of the TMDS clock is not notified by the detection signal B.

The receiving circuit 1 in this second embodiment may also be configured so as to count the predetermined period with the timer 16 after being notified of a TMDS clock stop by the detection signal B and so as not to decide a no-clock-input period as a link-OFF state until the next DDC clock or TMDS clock is inputted.

Using the timer 16 in such a way can keep a predetermined period during which none of the DDC clock and the TMDS clock is inputted as a link-ON state, thereby preventing the operation from being switched frequently between the power save mode and the display on mode. If such frequent mode switching is repeated, the receiving side device operation might become unstable. However, the timer 16 can prevent such frequent mode switching so as to stabilize the receiving side device operation.

While the preferred forms of the present invention have been described, it is to be understood that modifications will be apparent to those skilled in the art without departing the spirit of the invention. For example, the clock detecting method can be modified as needed in accordance with the subject circuit configuration.

1. A receiving circuit that receives send data including video data that are digital signals, the receiving circuit comprising:
a first clock detection circuit that detects presence of a read clock used to read a unique ID of a receiving side device;
a second clock detection circuit that detects presence of a send clock of the send data; and
a link state detection circuit that inputs a detection result of each of the first and second clock detection circuits and detects a link state with respect to a sending side device according to at least one of the read clock and the send clock.

2. The receiving circuit according to claim 1,
wherein the link state detection circuit includes a timer that counts a predetermined period starting at an input of the detection result of each of the first and second clock detection circuits; and
wherein the link state detection circuit decides a link-OFF state between the receiving circuit and the sending device if the timer count value exceeds the predetermined value.

3. The receiving circuit according to claim 1,
wherein the receiving circuit includes a first clock circuit that receives the read clock, a second clock receiving circuit that receives the send clock, and a control circuit that receives signals from the first and second clock receiving circuits to control its succeeding device connected thereto; and
wherein the control circuit controls the power state of the succeeding device according to the detection result of the link state detection circuit.

4. The receiving circuit according to claim 1,
wherein the receiving circuit conforms to the HDMI and DVI standards to receive the send data, as well as the read and send clocks.

5. The receiving circuit according to claim 1,
wherein the read clock is a DDC clock signal conforming to the HDMI and DVI standards and the send clock is a TMDS clock signal conforming to the HDMI and DVI standards.

6. The receiving circuit according to claim 2,
wherein the receiving circuit conforms to the HDMI and DVI standards to receive the send data, as well as the read and send clocks.

7. The receiving circuit according to claim 3,
wherein the receiving circuit conforms to the HDMI and DVI standards to receive the send data, as well as the read and send clocks.

8. The receiving circuit according to claim 2,
wherein the read clock is a DDC clock signal conforming to the HDMI and DVI standards and the send clock is a TMDS clock signal conforming to the HDMI and DVI standards.

9. The receiving circuit according to claim 3,
wherein the read clock is a DDC clock signal conforming to the HDMI and DVI standards and the send clock is a TMDS clock signal conforming to the HDMI and DVI standards.
